(19) United States
(12) Patent Application Publication
(10) Pub. No.: US 2022/0126568 A1
(43) Pub. Date: Apr. 28, 2022

(54) PRINTING MACHINE HAVING A PRINTING ROLL AND AN ANILOX ROLL OR AN ANILOX SLEEVE AND METHOD FOR ADJUSTING A PRINTING MACHINE

(71) Applicant: Heidelberger Druckmaschinen AG, Heidelberg (DE)

(72) Inventor: Werner Schwab, Bechtsrieth (DE)

(21) Appl. No.: 17/507,911

(22) Filed: Oct. 22, 2021

(30) Foreign Application Priority Data
Oct. 22, 2020 (DE) 102020213344.1

(51) Int. Cl. B41F 31/26; B41F 31/00

(52) U.S. Cl. CPC B41F 31/26; B41F 31/002

(57) ABSTRACT

A printing machine includes a printing roll and an anilox roll or an anilox sleeve for inking a printing forme of the printing roll. The anilox roll or the anilox sleeve is assigned a machine-readable ID. A sensor or a camera detects the ID. A computer retrieves data which is stored in a digital memory in relation to the ID detected from the memory. The computer performs adjustments on the printing machine on the basis of the ID which is read or the retrieved data. A method for adjusting a printing machine is also provided.

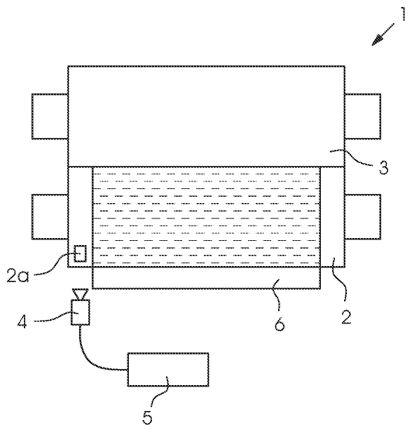

### CROSS-REFERENCE TO RELATED APPLICATION

This application claims the priority, under 35 U.S.C. § 119, of German Patent Application DE 10 2020 213 344.1, filed Oct. 22, 2020; the prior application is herewith incorporated by reference in its entirety.

### FIELD AND BACKGROUND OF THE INVENTION

The invention relates to a printing machine having a printing roll and an anilox roll or an anilox sleeve for inking a printing forme of the printing roll. The invention also relates to a method for adjusting a printing machine.

The invention lies in the technical field of the graphics industry and, in particular, in the area of the use of anilox rolls or anilox sleeves in printing machines, in particular in flexographic printing machines or in gravure printing machines.

### PRIOR ART

The market requires that, in the future, flexographic printing machines will print autonomously and reduce the stoppage times and start-up waste of the printing machine. It is also important that the machine makes adjustments during the production in order to supply constant printing quality. In that case, the inking system plays a critical role.

During the operation of the printing machine, the printing cylinder and the anilox roll are in contact; alternatively a printing cylinder can also be an air cylinder with a sleeve, on which the printing plate is mounted. Furthermore, there is still the possibility of sliding a laser-anilox sleeve onto an air cylinder, in order to obtain an endless printing cylinder (without any abutment points) in that way. The medium to be printed is led through between the printing roll and an impression roll.

The printing medium can be a web or else a sheet.

The anilox roll is a constituent part of a print inking unit. It is the storage medium which is intended to provide a necessary and defined quantity of ink constantly during the printing operation. On the surface of the roll, which is formed of ceramic or chromium, there are tiny, small cells or else lines, which are engraved by using various engraving methods. The non-depressed points are called lands, the depressions are generally called cells. An anilox roll can be formed of a core with a sleeve or of a core with engraving. The anilox roll can have its temperature controlled, for example with water.

The ink is normally applied through a chamber-type doctor system. With the aid of a doctor, the anilox roll surface, that is to say the lands, are freed of protruding ink. Thus, only a defined and therefore controllable quantity of ink remains in the depressions. The anilox roll transfers the printing ink directly to the printing plate/stereotype in flexographic printing, in that the depressions are always emptied uniformly. However, the emptying is never complete; during each rotation of the roll, mixing of ink takes place within the cells. As a result of the rotation of the anilox roll and the associated uniform take-up and removal of ink, the inking unit is supplied with a defined and reproducible volume of ink.

Critical parameters for the quantity of ink being transferred are the shape of the cells, their geometry, the opening and the material components of the anilox roll itself. The cell shape and depth in the roll surface determine how much ink can be picked up and discharged again. The engraving depth determines the volume of the cell. Although an engraving can be deep, it can nevertheless have the same theoretical volume as a flat engraving as a result of the shape and size of the cell.

Anilox rolls can have an extremely wide range of types of engraving. There are substantially hexagonal/pyramidal/truncated or dome-shaped cell structures or else linear structures or slalom engravings. In that case, the engraving can be coarse or else fine. In addition, engravings (pickup volumes) may be provided which transport much or little ink. Fine engravings with small ink volumes are normally taken in CMYK process inks in a 7-color CMYKOGV ink palette. Depending on the resolution of the printing plate, on the other hand, anilox rolls with a high ink transport capacity/pickup volume are used in the case of varnishes. Specific varnishes, together with the anilox roll, need varnish temperature control. The varnish temperature control can be influenced directly with the anilox roll (water throughput), for example by the latter being heated, or it is possible for the ink feed (e.g. hoses) or piping to have its temperature controlled through pipe trace heating or else the ink container itself or through an additional heat exchanger. Varnishes but also ink have their temperature controlled. In the case of varnishes, the aim of temperature control is to influence the “lying behavior” of the varnish positively.

The known prior art shows that there is no system which intervenes in a major way in the control on the basis of information about the anilox roll and performs adjustments during the setup and during production. The known prior art does not intervene in the machine adjustment during setup or during production.

Although prepress information is exchanged with offset printing machines through PDF/JDF/XJDF, there is at present no suitable and standardized interface for flexographic or gravure printing machines.

### SUMMARY OF THE INVENTION

It is accordingly an object of the invention to provide an improved printing machine having a printing roll and an anilox roll or an anilox sleeve, and a method for adjusting a printing machine, which overcome the hereinafore-mentioned disadvantages of the heretofore-known printing machines and methods of this general type.

With the foregoing and other objects in view there is provided, in accordance with the invention, a printing machine having a printing roll and an anilox roll or an anilox sleeve for inking a printing forme of the printing roll, the anilox roll or the anilox sleeve is assigned a machine-readable ID, a sensor or a camera is provided, which detects the ID, a computer retrieves data which is stored in a digital memory in relation to the ID detected from the memory and, on the basis of the ID read or the retrieved data, the computer performs adjustments on the printing machine.

The performance of the adjustment on the basis of the ID read or the retrieved data can be carried out by the ID itself being used and/or by data stored in relation to the ID and relating to the anilox roll or anilox sleeve or the engraving (e.g. cell depth) being used.

Provision can preferably be made that:

the anilox roll is marked with an ID and the ID has information relating to the transfer volume and, for example, geometry, ruling and/or depth of each of the cells and their angulation; or

the anilox roll is marked with an ID and, in relation to this ID, information such as transfer volume, geometry, ruling and/or depth of each of the cells and their angulation is stored in a data memory or a cloud memory.

The ID can be provided as a chain of symbols.

A device according to the invention or a method according to the invention is used to supply and discharge printing ink to and from a doctor device of an inking unit of a rotary printing machine. With the aid of the method, the inking system of a flexographic printing machine is adjusted automatically. Firstly, during a change in the anilox roll and also in the printing process. The anilox roll or the anilox sleeve is detected by using an identification feature. From the data, various adjustments are made on the inking system of the printing machine. This is done by using stored data and with the aid of algorithms. The adjustments are carried out autonomously; appropriate adjustment data for the flexographic printing machine is derived.

A device according to the invention or a method according to the invention offers considerable added value in the direction of automation and increases the customer benefit. It not only offers the setting of the ideal adjustment for the inking system during setup and during production, which is carried out automatically, as required by the market, but penetrates much deeper into the flexographic or gravure printing process in order to supply constant printing quality over all speed ranges. They can predict data for the flexographic or gravure printing process and therefore, in the print shop, increase the efficiency, lower costs and reduce risks.

The invention is based, for example, on the finding that the smallest screen dot of the stereotype/printing plate in flexographic printing should always be larger than the anilox cells on the anilox roll. Thus, the screen dot dips into the cell, picks up too much ink and the over-inking of the screen dot leads to printing difficulties, for example moiré formation or so-called bridging. For example, with a screen width of 48 L/cm of the flexographic printing plate, the anilox roll should have at least a 240 L/cm screen width, that is say at least the factor 5.

The invention is also based, for example, on the finding that high printing quality is accordingly achieved by conformal transfer of ink between printing plate and anilox roll. The selection of the anilox roll must be made correctly, depending on the area of application of the printing substrate (e.g. board or film or aluminum), and take the printing ink into account, for example its viscosity.

The invention advantageously makes it possible to automate adjustments on the printing machine with regard to the inking system, including, for example, anilox roll, doctor system, doctor blade system, ink feed, ink temperature, ink viscosity, ink pump, ink drying and ink circulation system cleaning.

Preferred exemplary developments of the invention can be characterized as follows:

the memory is a memory of the computer or a memory in a local or external network or a memory in a cloud. A local network is preferably a network to which the printing machine is also directly connected, for example the network of a print shop. An external network is preferably a group of multiple such local networks, for example a company network. The invention can also be a system including a printing machine and a memory.

the data is stored in at least one file in the memory.

the data is stored in a database in the memory.

the ID is present on the anilox roll or the anilox sleeve, for example is applied to its surface or introduced into its surface (preferably introduced with a laser).

the ID is present on a body assigned to the anilox roll or the anilox sleeve. The body can be present separately from the anilox roll or the anilox sleeve.

the body is magnetic. Such a body can if necessary be attached to the anilox roll or the anilox sleeve and removed again.

the body is an information carrier, for example made of film or paper.

the printing roll is a flexographic printing cylinder or a gravure printing cylinder.

the ID is a one-dimensional or two-dimensional optically readable code or a readable RFID chip or an NFC chip.

a chamber-type doctor (6) is provided to supply the anilox roll (2) or the anilox sleeve (2) with printing ink.

at least one of the following adjustments is made:

a. presetting and/or adjusting and/or changing the position of the AS/BS positioning of the anilox roll or anilox sleeve relative to the printing roll by using the geometric shape of the anilox roll or anilox sleeve for presetting and/or adjusting and/or changing the printing pressure, i.e. the distance and/or the position and/or the pressure between the anilox roll or anilox sleeve, on the one hand, and the printing roll, on the other hand. The geometric shape can be given as: the radii or the diameters of the anilox roll or the anilox sleeve i) on the AS and BS and/or ii) in the course between the AS and BS; where AS is the so-called drive side and BS is the operator's side opposite the latter in the printing machine.
b. adjusting the dynamic printing pressure as a function of the printing speed;
c. adjusting the dynamic printing pressure as a function of the printing speed and the dot density and the type of a printing forme disposed on the printing roll;
d. adjusting a doctor blade by using the abrasiveness of the anilox roll or anilox sleeve and/or by using a current or power consumption of a rotary motor of the anilox roll or the anilox sleeve, automatically through a motorized infeed of the doctor blade;
e. readjusting the doctor blade by using the abrasiveness of the anilox roll or anilox sleeve, automatically by using a motor or as an output to an operator;
f. adjusting a dryer system, i.e. its dryer air temperature and/or dryer air velocity, as a function of the printing speed;
g. adjusting a curing system in the case of light-sensitive or radiation-sensitive printing inks as a function of the printing speed;
h. adjusting the idle running speed (so-called idle run) by using the ink/s, varnish/es used and/or characteristic variables of the anilox roll;
i. automatically selecting a washing program for ink cleaning, if appropriate also as a function of the viscosity of the inking system used;
j. automatically selecting a washing program for ink cleaning as a function of the viscosity of the ink used;
k. automatically adjusting and regulating ink temperature control;
l. automatically adjusting an ink feed as a function of the printing speed;
m. automatically adjusting an ink feed as a function of the printing speed by changing the delivery output of an ink pump; and/or
n. adjusting and regulating a viscosity value of the ink used.

at least one of the following measures is taken:

a. comparing anilox rolls or anilox sleeves used in each printing unit by using pre-press information;
b. comparing anilox rolls or anilox sleeves used in each printing unit by using a memory for print jobs in the case of repeated jobs;
c. outputting the characteristic variables of the anilox roll or anilox sleeve to an operator, wherein the output is made on a printing unit, smartphone, tablet or control desk;
d. outputting an overview of the anilox rolls or anilox sleeves used in the machine to an operator;
e. outputting a recommendation to use an anilox roll or anilox sleeve by using the screen dot size of the printing plate;
f. outputting a recommendation to use an anilox roll or anilox sleeve by using the smallest screen dot size of the printing plate;
g. in the event of erroneous use of an anilox roll or anilox sleeve, warning by using the (smallest) screen dot size of the printing plate, in order to prevent moiré or ink bridge formation;
h. predicting the ink consumption by using the anilox roll or anilox sleeve used and the printing areas and/or dot densities on the printing plate;
i. outputting an indication of the wear of the anilox roll or anilox sleeve on the basis of manufacturer, material, abrasiveness, cell shape, engraving, running time on the machine and power consumption of the rotary motor of the anilox roll or anilox sleeve;
j. cleaning the anilox roll or anilox sleeve with ultrasound.

Further preferred exemplary developments of the invention can be distinguished as illustrated in the following text of this section.

Determining the data by using the ID or directly in the surface code/RFID of the anilox roll/of the anilox sleeve. An identification device is needed for each printing unit.

Identification of the anilox roll:

a. A possible identification of the anilox roll is with a bar code at the edge of the anilox roll, in order to obtain a unique ID. Corresponding important characteristic values and data relating to the ID, see, for example, below, are then stored in the control system.
b. A surface code on the anilox roll or the anilox sleeve in the edge region is likewise possible. In the surface code, either all of the important properties are already described, that is to say, for example, geometry of the cells, ruling [L/cm], depth [μm], angulation [°], volume [cm³/m²], land/cell ratio [I:x], or in turn a unique ID is lasered on in the surface code, where important characteristic variables and data are stored in the control system, see above.

There are various surface codes, QR code, data matrix, etc.

Alternatively, an integrated NFC could also be used.

The ID or the data of the anilox roll is transferred into the machine control system from the machine through a reader. The machine then carries out adjustments.

The data flow from prepress stage to the printing machine is considerably more complicated in flexographic and gravure printing as compared with offset or digital printing. Prepress stage and print are generally separated in this case. This means that a prepress operation supplies different print shops with printing formes, and print shops obtain printing formes from different prepress operations.

Furthermore, entire print jobs are combined efficiently from different printing plates over the working width shortly before production.

Moreover, prepress stage and print are not under one roof and cannot therefore also be interlinked simply through network cables, which means that data from the prepress stage is not available directly to the printing machine. A method for the automatic adjustment of the inking system in a flexographic printing machine, including the position adjustment for the anilox roll, begins precisely at this point and carries out or checks adjustments.

In the known prior art, no interface which brings prepress data directly to a flexographic or gravure printing machine is known. One possible solution in this case could be the sector standard JDF or XJDF, which has been established successfully in digital and offset printing as a cross-manufacturer interface.

The method for automatic adjustment of the ink system in a flexographic printing machine, including the position adjustment for the anilox roll, is a practical extension to a measuring device/measuring method relating to the measurement of elevations of a flexographic printing forme, as applied for in German Patent Application DE 10 2020 111 341 A1, corresponding to U.S. Patent Application Publication 2020/0353742 A1.

It could be possible for other sensors or other identification systems to be used. From today's perspective, an imaging method or sensors which react to electromagnetic waves is beneficial and most suitable.

One possible future step could, however, be applying the prepress data directly to the anilox roll or in the printing unit—or making the same available to the printing machine, but the identification as to which engraved roll has been or is inserted continues to exist. However, the system is in a position to process prepress data in the form of (PDFs/JDFs/XJDFs) and in addition to assign these to the printing units being used.

Other features which are considered as characteristic for the invention are set forth in the appended claims.

Although the invention is illustrated and described herein as embodied in a printing machine having a printing roll and an anilox roll or an anilox sleeve, and a method for adjusting a printing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

The FIGURE of the drawing is a side-elevational view of a printing machine according to the invention.

### DETAILED DESCRIPTION OF THE INVENTION

Referring now in detail to the single FIGURE of the drawing, there is seen a printing machine 1 according to the invention having an anilox roll 2 (alternatively: having an anilox sleeve 2) and a printing roll 3 (which can also be designated as a printing cylinder).

The printing roll is preferably a flexographic printing cylinder with a sleeve and flexographic plates mounted thereon (alternatively: preferably a gravure printing cylinder). Ink is preferably supplied by using a chamber-type doctor 6.

The anilox roll includes an ID 2a. The ID can be a one-dimensional bar code or a two-dimensional matrix code. The ID can be read optically. To this end, the printing machine 1 includes a sensor 4 or a camera 4. The ID can alternatively be an NFC chip or an RFID chip. Instead of the sensor/camera, an appropriate reader 4 is provided in this case.

The ID which is read is transmitted to a computer 5 of the printing machine 1. The ID can simply be a unique identification of the anilox roll, for example a number. However, it can also contain further information relating to the anilox roll, e.g. the engraving type and/or the engraving depth.vv

The computer 5 is preferably connected to at least one actuating device (not illustrated) of the printing machine, for example to a motor or an ink pump of the ink supply.

The computer 5 performs at least one adjustment on the printing machine 1, on the basis of which the ID is read.

The following is a summary list of reference numerals and the corresponding structure used in the above description of the invention:
1 Printing machine/device
2 Anilox roll/anilox sleeve
2a ID/identification feature
3 Printing roll
4 Sensor/camera
5 Computer
6 Chamber-type doctor

1. A printing machine, comprising:
a printing roll for carrying a printing forme;
an anilox roll or an anilox sleeve for inking the printing forme;
a machine-readable ID assigned to said anilox roll or said anilox sleeve;
a sensor or a camera for detecting said ID; and
a computer retrieving data stored in a digital memory in relation to said ID detected from said digital memory, said computer performing adjustments on the printing machine based on said ID being read or said retrieved data.

2. The printing machine according to claim 1, wherein said digital memory is a memory of said computer or a memory in a local or external network or a memory in a cloud.

3. The printing machine according to claim 1, wherein said data is stored in at least one file in said digital memory.

4. The printing machine according to claim 1, wherein said data is stored in a database in said digital memory.

5. The printing machine according to claim 1, wherein said ID is disposed on said anilox roll or on said anilox sleeve.

6. The printing machine according to claim 1, wherein said ID is disposed on a body assigned to said anilox roll or to said anilox sleeve.

7. The printing machine according to claim 6, wherein said body is magnetic.

8. The printing machine according to claim 1, wherein said printing roll is a flexographic printing cylinder or a gravure printing cylinder.

9. The printing machine according to claim 1, wherein said ID is a one-dimensional or two-dimensional optically readable code or a readable RFID chip or an NFC chip.

10. The printing machine according to claim 1, which further comprises a chamber-type doctor for supplying said anilox roll or said anilox sleeve with printing ink.

11. A method for adjusting a printing machine, the method comprising:
providing a printing machine according to claim 1; and
making at least one adjustment as follows:
at least one of presetting or adjusting or changing a position of AS/BS positioning of said anilox roll or said anilox sleeve relative to said printing roll by using a geometric shape of said anilox roll or said anilox sleeve for at least one of presetting or adjusting or changing a printing pressure and at least one of a distance or a position or a pressure between said anilox roll or said anilox sleeve and said printing roll;
adjusting a dynamic printing pressure as a function of a printing speed;
adjusting the dynamic printing pressure as a function of the printing speed and a dot density and a type of the printing forme disposed on said printing roll;
adjusting a doctor blade by using at least one of an abrasiveness of said anilox roll or said anilox sleeve or a current or power consumption of a rotary motor of said anilox roll or said anilox sleeve, automatically through a motorized infeed of said doctor blade;
readjusting said doctor blade by using the abrasiveness of said anilox roll or said anilox sleeve, automatically by using a motor or as an output to an operator;
adjusting a dryer system and at least one of a dryer air temperature or a dryer air velocity, as a function of the printing speed;
adjusting a curing system when using light-sensitive or radiation-sensitive printing inks as a function of the printing speed;
adjusting an idle running speed by using at least one of ink, varnish or characteristic variables of said anilox roll;
automatically selecting a washing program for ink cleaning or as a function of a viscosity of an inking system being used;
automatically selecting a washing program for ink cleaning as a function of the viscosity of the ink being used;
automatically adjusting and regulating an ink temperature control;
automatically adjusting an ink feed as a function of the printing speed;
automatically adjusting an ink feed as a function of the printing speed by changing a delivery output of an ink pump; or
adjusting and regulating a viscosity value of the ink being used.

12. A method for adjusting a printing machine, the method comprising:
providing a printing machine according to claim 1; and
taking at least one measure as follows:
comparing anilox rolls or anilox sleeves used in each of a plurality of printing units by using pre-press information;
comparing said anilox rolls or said anilox sleeves used in each printing unit by using a memory for print jobs upon carrying out repeated jobs;
outputting characteristic variables of said anilox roll or said anilox sleeves to an operator, and carrying out the output on a printing unit, smartphone, tablet or control desk;
outputting an overview of said anilox rolls or said anilox sleeves used in the machine to an operator;
outputting a recommendation to use an anilox roll or anilox sleeve by using a screen dot size of the printing plate;
outputting a recommendation to use an anilox roll or anilox sleeve by using a smallest screen dot size of the printing plate;
in an event of an erroneous use of an anilox roll or anilox sleeve, providing a warning by using the screen dot size of the printing plate to prevent moiré or ink bridge formation;
in an event of an erroneous use of an anilox roll or anilox sleeve, providing a warning by using a smallest screen dot size of the printing plate to prevent moiré or ink bridge formation;
predicting an ink consumption by using said anilox roll or said anilox sleeve and at least one of printing areas or dot densities on the printing plate; or
outputting an indication of wear of said anilox roll or said anilox sleeve based on manufacturer, material, abrasiveness, cell shape, engraving, running time on the machine and power consumption of a rotary motor of said anilox roll or said anilox sleeve; and
cleaning said anilox roll or said anilox sleeve with ultrasound.
